(19) United States
(12) Patent Application Publication
(10) Pub. No.: US 2026/0191711 A1
(43) Pub. Date: Jul. 9, 2026

(54) Modular Patient Support And Method Of Assembling Thereof

(71) Applicant: Stryker Corporation, Portage, MI (US)

(72) Inventors: Berkay Güncan, Kayseri (TR); Murat Serkan Kantarci, Kayseri (TR); Mehmet Zihni Gürlek, Kayseri (TR)

(73) Assignee: Stryker Corporation, Portage, MI (US)

(21) Appl. No.: 19/121,931

(22) PCT Filed: Oct. 19, 2023
(86) PCT No.: PCT/US2023/035472

§ 371 Date: Apr. 17, 2025

Related U.S. Application Data
(60) Provisional application No. 63/417,512, filed on Oct. 19, 2022.

(51) Int. Cl. A61G 7/012; A61G 7/05

(52) U.S. Cl. CPC A61G 7/012; A61G 7/0527

(57) ABSTRACT

A modular patient support system includes a base assembly and a litter assembly. The litter assembly may include one of a first litter assembly including a first litter support structure having a first configuration and a second litter assembly including a second litter support structure having a second configuration, different than the first configuration.

### CROSS-REFERENCE TO RELATED APPLICATION(S)

The subject patent application claims priority to and all the benefits of U.S. Provisional Ser. No. 63/417,512 filed on Oct. 19, 2022, the disclosure of which is hereby incorporated by reference in its entirety.

### BACKGROUND

A patient support apparatus, such as a hospital bed, facilitates care of patients in a health care setting. A conventional patient support apparatus includes a base and a litter coupled to the base. In some types of patient support apparatuses, a lift mechanism may be employed to adjust a vertical position of the litter. It will be appreciated that, depending on the specific configuration and arrangement of the components and assemblies of the patient support apparatus, the manufacturing process may involve relatively labor-intensive assembly steps. For example, because of how certain types of lift mechanisms are coupled between the base and the litter, various heavy components and systems may need to be supported in multiple directions in order to ensure that bushings, bearings, fasteners, and the like can be installed properly. Here too, patient support apparatuses which employ features or systems that are different from one another may be assembled on separate production lines even where many of their components and systems are similar to each other.

There remains a need in the art to overcome one or more of the disadvantages described above.

### SUMMARY

One aspect of the present disclosure includes a modular patient support system including a litter assembly including one of a first litter support structure and a second litter support structure. The first litter support structure may have a first configuration and a first litter support receiver operatively attached to the first litter support structure. The second litter support structure may have a second configuration, different than the first configuration, and a second litter support receiver operatively attached to the second litter support structure. The modular patient support system also includes a base assembly. The base assembly may include a base frame, a litter support coupler configured to engage one of the first litter support receiver and the second litter support receiver to couple the litter assembly to the base assembly, and a lift mechanism. The lift mechanism may extend between the base frame and the litter support coupler and be configured to move the litter support coupler between a plurality of vertical configurations relative to the base frame.

Another aspect includes a patient support apparatus including a base assembly. The base assembly may include a base frame, a litter support coupler including a mounting member, and a lift mechanism. The lift mechanism may extend between the base frame and the litter support coupler and be configured to move the litter support coupler between a plurality of vertical configurations relative to the base frame. The patient support apparatus also includes a litter support adapter engaged with the mounting member. The patient support apparatus further includes a litter assembly including a litter support structure, and a litter support receiver for coupling the litter assembly to the base assembly. The litter support receiver may include a litter support brace operatively attached to the litter support structure and shaped for engagement with the litter support adapter to couple the litter assembly to the base assembly.

The present disclosure also includes a method of assembling a patient support apparatus. The method includes a step of (a) providing a base assembly including a litter support coupler. The method also includes a step of (b) selecting one of a first litter assembly including a first litter support structure having a first configuration and a first litter support receiver, and a second litter assembly including a second litter support structure having a second configuration, different from the first configuration, and a second litter support receiver. The method further includes a step of (c) coupling the litter support receiver of the litter assembly selected in step (b) to the litter support coupler to couple the litter assembly selected in step (b) to the base assembly.

The present disclosure further includes another method of assembling a patient support apparatus. The method includes providing a base assembly including a litter support coupler having a mounting member, providing a litter support adapter defining an adapter void shaped to receive the mounting member, and providing a litter assembly including a litter support receiver having a litter support brace shaped for engagement with the litter support adapter. The method also includes disposing the mounting member within the adapter void to couple the litter support adapter to the litter support coupler and coupling the litter support brace to the litter support adapter to couple the litter assembly to the base assembly.

### BRIEF DESCRIPTION OF THE DRAWINGS

FIG. 1 is a top perspective view of a modular patient support system.

FIG. 2 is a flowchart illustrating a method of assembling a patient support apparatus.

FIG. 3A is a top perspective view of one configuration of a patient support apparatus including a base assembly and a litter assembly having a first litter support structure having a first configuration.

FIG. 3B is a top perspective view of another configuration of a patient support apparatus including a base assembly and a litter assembly having a second litter support structure having a second configuration.

FIG. 4 is a top perspective view of yet another configuration of a patient support apparatus.

FIG. 5 is a schematic view of a control system.

FIG. 6A is a top perspective view of one configuration of a litter assembly including the first litter support structure having the first configuration.

FIG. 6B is a side view of the litter assembly of FIG. 6A.

FIG. 7A is a top perspective view of another configuration of a litter assembly including the second litter support structure having the second configuration.

FIG. 7B is a side view of the litter assembly of FIG. 7A.

FIG. 8A is an exploded view illustrating a load cell assembly interposed between a weigh frame and an intermediate frame of the litter assembly.

FIG. 8B is a partial side view of the litter assembly showing the load cell assembly interposed between the weigh frame and the intermediate frame.

FIG. 9A is a top perspective view of one configuration of the base assembly including a lift mechanism in a raised configuration.

FIG. 9B is a side view of the base assembly of FIG. 9A.

FIG. 10A is a top perspective view of one configuration of the base assembly including the lift mechanism in an intermediate configuration.

FIG. 10B is a side view of the base assembly of FIG. 10A.

FIG. 11A is a top perspective view of one configuration of the base assembly including the lift mechanism in a lowered configuration.

FIG. 11B is a side view of the base assembly of FIG. 11A.

FIGS. 12A-12C are perspective views showing the lift mechanism of the patient support apparatus including a head end actuator and a foot end actuator for moving the litter assembly relative to the base assembly.

FIG. 13 shows a partial bottom perspective view of one configuration of a litter support receiver.

FIGS. 14A and 14B show perspective views of a litter support adapter.

FIG. 15 is a flowchart illustrating a method of coupling the litter assembly to the base assembly.

FIG. 16A shows an exploded view of the litter support receiver and the litter support adapter spaced from the litter support coupler.

FIG. 16B shows an exploded view of the litter support adapter engaged with the litter support coupler and the litter support receiver spaced from the litter support adapter.

FIG. 16C shows an exploded view of the litter support receiver engaged with the litter support adapter and the litter support adapter engaged with the litter support coupler, and fasteners spaced from the litter support receiver.

FIG. 16D shows a top perspective view of the er support receiver engaged with the litter support adapter and the litter support adapter engaged with the litter support coupler.

FIG. 17 shows a cross section of the litter support receiver coupled to the litter support adapter.

### DETAILED DESCRIPTION

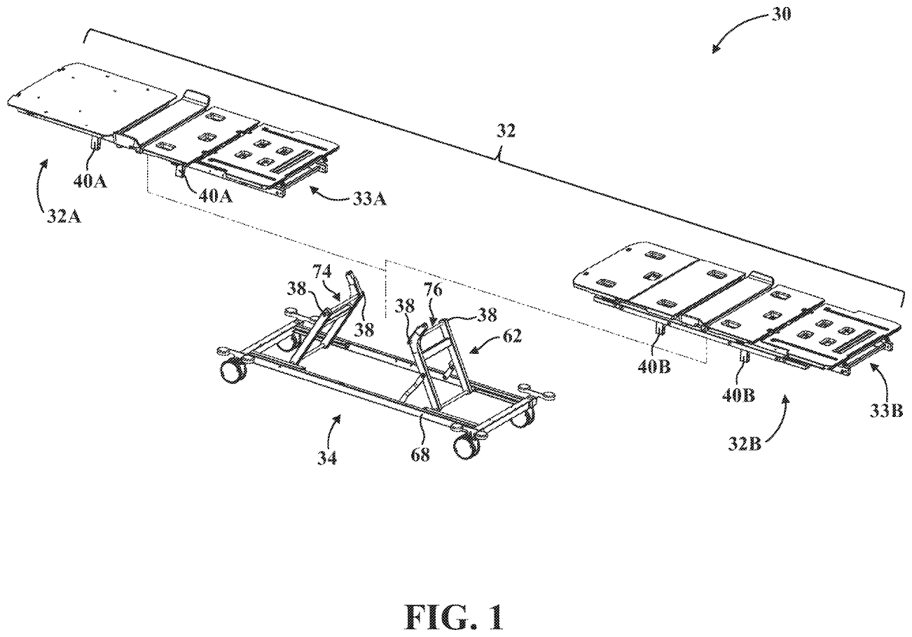

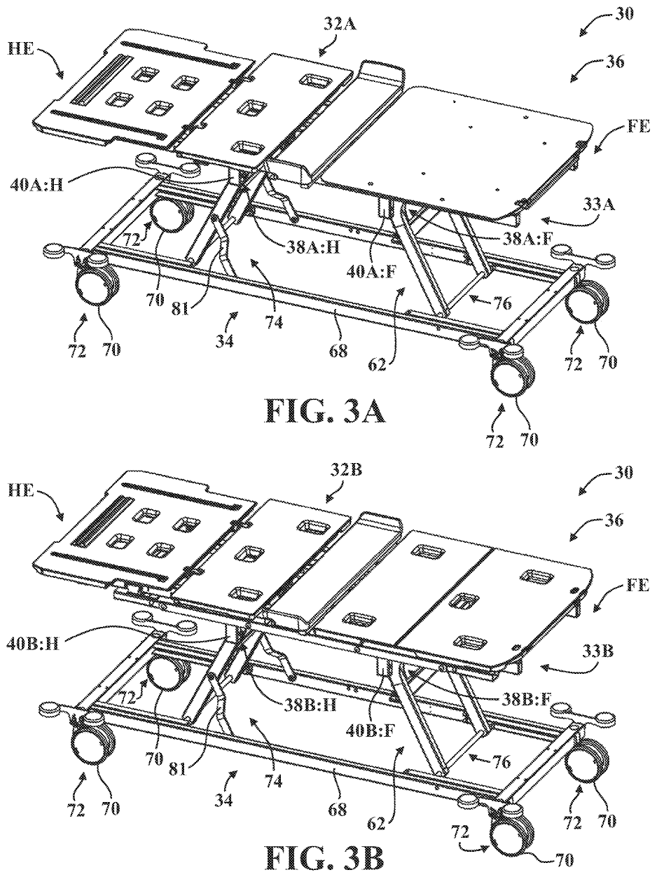

Referring to FIG. 1, the present disclosure includes a modular patient support system 30 including a litter assembly 32 and a base assembly 34. The modular patient support system 30 may form a patient support apparatus 36, such as a hospital bed as shown in FIGS. 3A and 3B. In other versions, however, the modular patient support system 30 may form a stretcher, cot, table, wheelchair, or similar apparatus utilized in the care of a patient. The base assembly 34 of the modular patient support system 30 is configured to be used with litter assemblies 32 having different structures/configurations. For example, the litter assembly 32 may include one of a first litter support structure 33A (described below) and a second litter support structure 33B (described below) that is different from the first litter support structure 33A. As described in further detail below, one of the first litter support structure 33A and the second litter support structure 33B are selected and coupled to the base assembly 34 to form a patient support apparatus 36 for supporting patients. Additional litter support structures beyond a first and a second configuration (e.g., a second configuration, third configuration, fourth configuration, etc.) may be coupled to the base assembly 34. It will be appreciated that the modular patient support system 30 of the present disclosure affords significant manufacturing and cost advantages by increasing common parts between models and allowing for substantially less complex assembly during manufacturing.

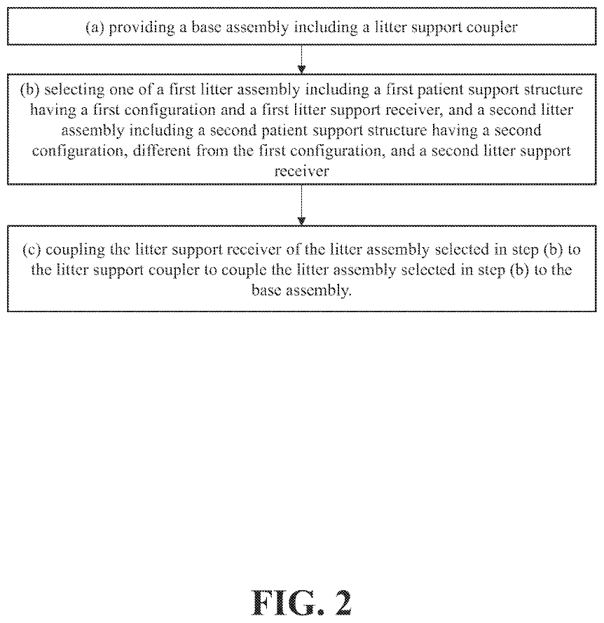

Referring to FIG. 2, the present disclosure also includes a method of assembling a patient support apparatus 36. The method includes a step (a) of providing the base assembly 34 including a litter support coupler 38 (described below). The method also includes a step (b) of selecting one of a first litter assembly 32A and a second litter assembly 32B. The first litter assembly 32A may include the first litter support structure 33A and a first litter support receiver 40A (described below). The second litter assembly 32B may include the second litter support structure 33B, different from the first litter support structure 33A, and a second litter support receiver 40B (described below). The method further includes a step (c) of coupling the litter support receiver 40 of the litter assembly 32 selected in step (b) to the litter support coupler 38 to couple the litter assembly 32 selected in step (b) to the base assembly 34. Ultimately, the method forms the patient support apparatus 36 which includes a base assembly 34 and a litter assembly 32 (either the first litter assembly 32A or the second litter assembly 32B).

FIGS. 3A and 3B show examples of the patient support apparatus 36. In FIG. 3A, a patient support apparatus 36 is shown which includes the first litter assembly 32A coupled to the base assembly 34. The first litter assembly 32A includes the first litter support structure 33A having a first configuration and the first litter support receiver 40A operatively attached to the first litter support structure 33A. In FIG. 3B, a patient support apparatus 36 is shown which includes the second litter assembly 32B coupled to the base assembly 34. The second litter assembly 32B includes the second litter support structure 33B having a second configuration, different than the first configuration, and the second litter support receiver 40B operatively attached to the second litter support structure 33B. As described in further detail below, the litter support coupler 38 is configured to engage one of the first litter support receiver 40A and the second litter support receiver 40B to couple the litter assembly 32 to the base assembly 34.

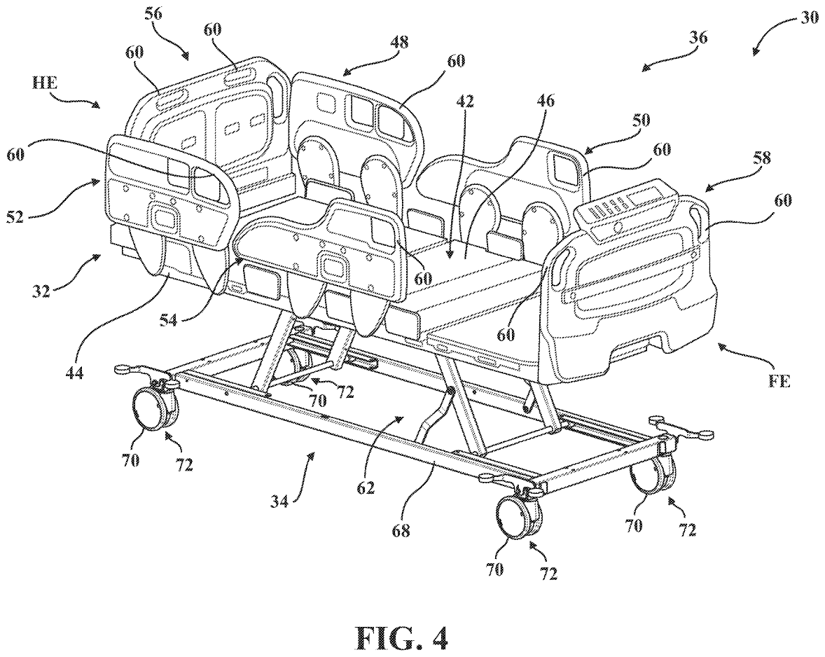

Referring to FIG. 4, the litter assembly 32 (either the first litter assembly 32A or the second litter assembly 32B) may include a patient support deck 42 operatively attached to an intermediate frame 44 (described below) of the litter assembly 32. The patient support deck 42 may include several sections, some of which are capable of articulating (e.g., pivoting) relative to the intermediate frame 44, such as a fowler section, a seat section, a thigh section, and a foot section. The patient support deck 42 provides a patient support surface 46 upon which the patient is supported. In some configurations, a mattress (not shown) is disposed on the patient support deck 42 during use. The mattress may include a secondary patient support surface upon which the patient is supported. In addition, the mattress may be omitted in certain versions, such that the patient rests directly on the patient support surface 46. The litter assembly 32, base assembly 34, intermediate frame 44, patient support deck 42, and patient support surface 46 each have a head end HE and a foot end FE corresponding to designated placement of the patient's head and feet on the patient support apparatus 36.

In some configurations, side rails 48, 50, 52, 54 may be coupled to the litter assembly 32. A first side rail 48 is positioned at a right head end of the patient support deck 42. A second side rail 50 is positioned at a right foot end of the patient support deck 42. A third side rail 52 is positioned at a left head end of the patient support deck 42. A fourth side rail 54 is positioned at a left foot end of the patient support deck 42. If the patient support apparatus 36 is a stretcher or a cot, there may be fewer side rails. The side rails 48, 50, 52, 54 are movable between a raised position in which they block ingress and egress into and out of the patient support apparatus 36, one or more intermediate positions, and a lowered position in which they are not an obstacle to such ingress and egress. In some configurations, the patient support apparatus 36 may not include any side rails.

Additionally, a headboard 56 and a footboard 58 may be coupled to the litter assembly 32. In some versions, when the headboard 56 and footboard 58 are included, the headboard 56 and footboard 58 may be coupled to other locations on the patient support apparatus 36, such as the base assembly 34. In some versions, the patient support apparatus 36 does not include the headboard 56 and/or the footboard 58. Further, in some configurations, caregiver interfaces 60, such as handles, may be integrated into one or more of the side rails 48, 50, 52, 54, headboard 56, and the footboard 58 to facilitate movement of the patient support apparatus 36 over floor surfaces. The caregiver interfaces 60 are graspable by the caregiver to manipulate the patient support apparatus 36 for movement.

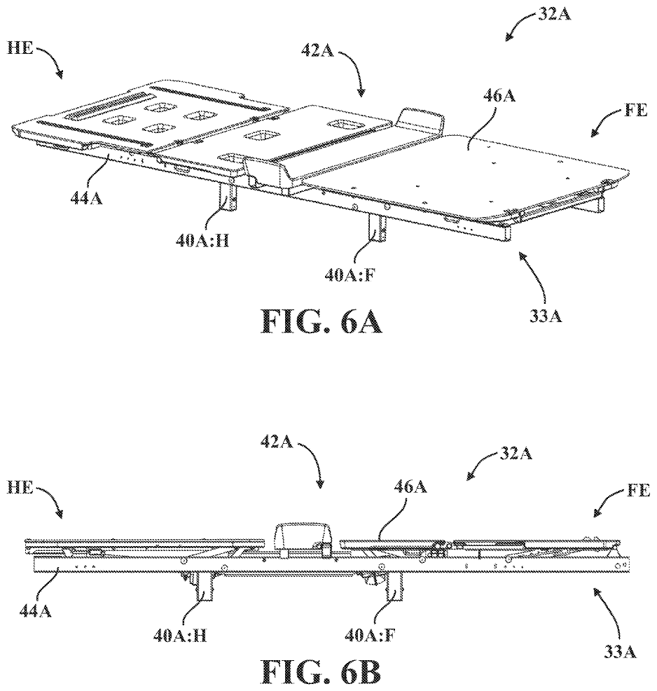

Referring to FIGS. 6A and 6B, one configuration of the litter assembly 32 (also referred to as the first litter assembly 32A) is shown. In this example, the litter assembly 32 includes the first litter support structure 33A. The first litter support structure 33A may include a first intermediate frame 44A. In this configuration, the patient support deck 42 is a first patient support deck 42A and the patient support surface 46 is a first patient support surface 46A for supporting a patient. The first patient support deck 42A may be operatively attached to the first intermediate frame 44A. In this configuration, the litter support receiver 40 is further defined as the first litter support receiver 40A. The first litter support receiver 40A may be operatively attached to the first intermediate frame 44A to engage the litter support coupler 38 to couple the litter assembly 32 to the base assembly 34. For example, the first litter support receiver 40A may be coupled to and extend from the first intermediate frame 44A.

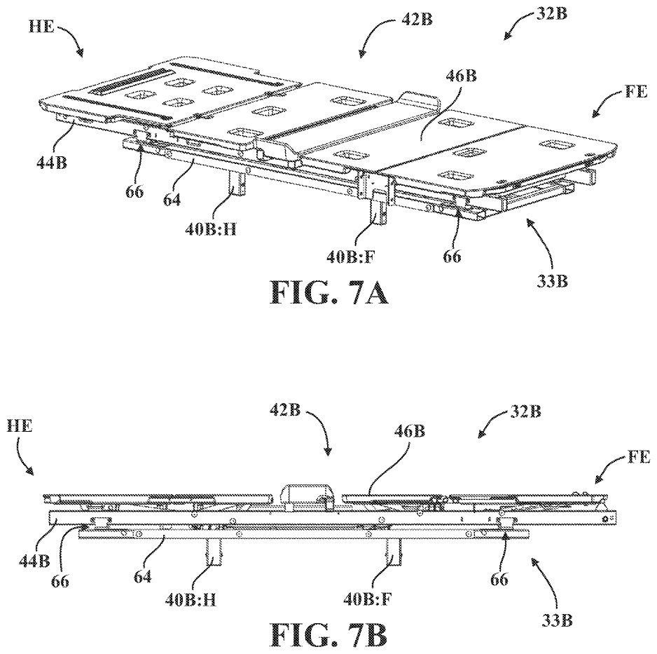

Referring to FIGS. 7A and 7B, another configuration of the litter assembly 32 (also referred to as the second litter assembly 32B) is shown. In this example, the litter assembly 32 includes the second litter support structure 33B. The second litter support structure 33B may include a weigh frame 64 and a second intermediate frame 44B operatively attached to the weigh frame. In this configuration, the patient support deck 42 is a second patient support deck 42B and the patient support surface 46 is a second patient support surface 46B for supporting a patient. The second patient support deck 42B may be operatively attached to the second intermediate frame 44B. In this configuration, the litter support receiver 40 is further defined as the second litter support receiver 40B. The second litter support receiver 40B may be operatively attached to the weigh frame 64 to engage the litter support coupler 38 to couple the litter assembly 32 to the base assembly 34. For example, the second litter support receiver 40B may be coupled to and extend from the weigh frame 64.

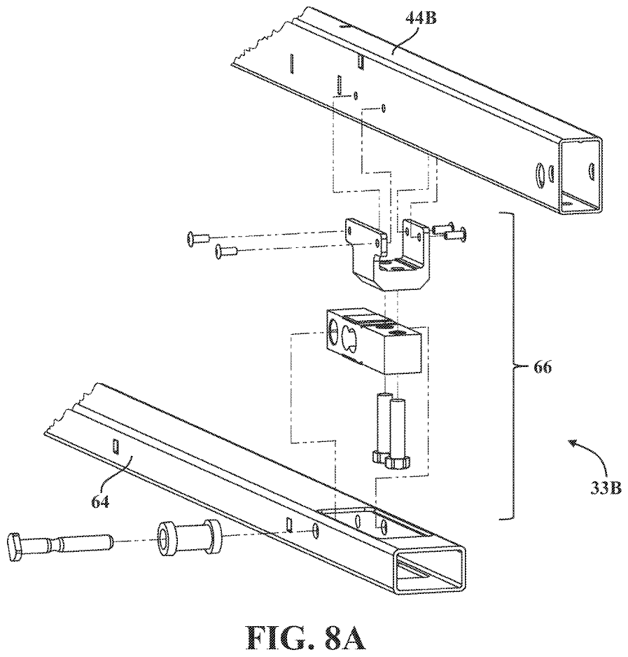

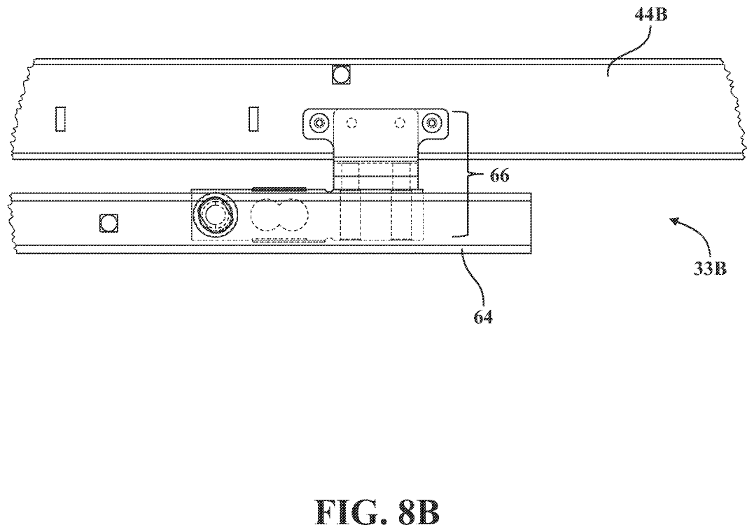

In some examples, the litter assembly 32 may include a weigh system for measuring, monitoring, sensing, or otherwise detecting load on the patient support surface 46. For example, in some configurations, such as the first litter support structure 33A, the litter assembly 32 may not include a weigh frame 64, and thus the litter assembly 32 does not include a weigh system. However, other configurations, such as the second litter support structure 33B, the litter assembly 32 includes a weigh frame 64, and thus the litter assembly 32 may include a weigh system. In configurations that include the weigh system, the litter support structure 33 may further include a plurality of load cell assemblies 66 interposed between the intermediate frame 44 and the weigh frame 64 to measure load about the patient support surface 46. For example, the second litter support structure 33B may further include a plurality of load cell assemblies 66 interposed between the second intermediate frame 44B and the weigh frame 64 to measure load about the second patient support surface 46B. FIGS. 8A and 8B show an example arrangement for interposing one of the load cell assemblies 66 between the weigh frame 64 and the second intermediate frame 44B. This arrangement is disclosed and described in U.S. Provisional Patent Application No. 63/255,127 filed on Oct. 13, 2021, which is incorporated by reference herein. Other configurations of a weigh system configured to measure load about the patient support surface 46 are contemplated.

FIGS. 1, 3A-4, and 9A-12C show one example of the base assembly 34. The base assembly 34 includes a base frame 68. Wheels 70 may be coupled to the base frame 68 to facilitate transport about floor surfaces. The wheels 70 may be arranged in each of four quadrants of the base frame 68 adjacent to corners of the base frame 68. In the version shown, the wheels 70 are caster wheels able to rotate and swivel relative to the base frame 68 during transport. Each of the wheels 70 may form part of a caster assembly 72. Each caster assembly 72 is mounted to the base frame 68. It should be understood that various configurations of the caster assemblies 72 are contemplated. In addition, in some versions, the wheels 70 are not caster wheels and may be non-steerable, steerable, non-powered, powered, or combinations thereof. Additional wheels are also contemplated. For example, the base assembly 34 may include four non-powered, non-steerable wheels, along with one or more powered wheels. In some cases, the base assembly 34 may not include any wheels. In some versions, one or more auxiliary wheels (powered or non-powered), which are movable between stowed positions and deployed positions, may be coupled to the base assembly 34.

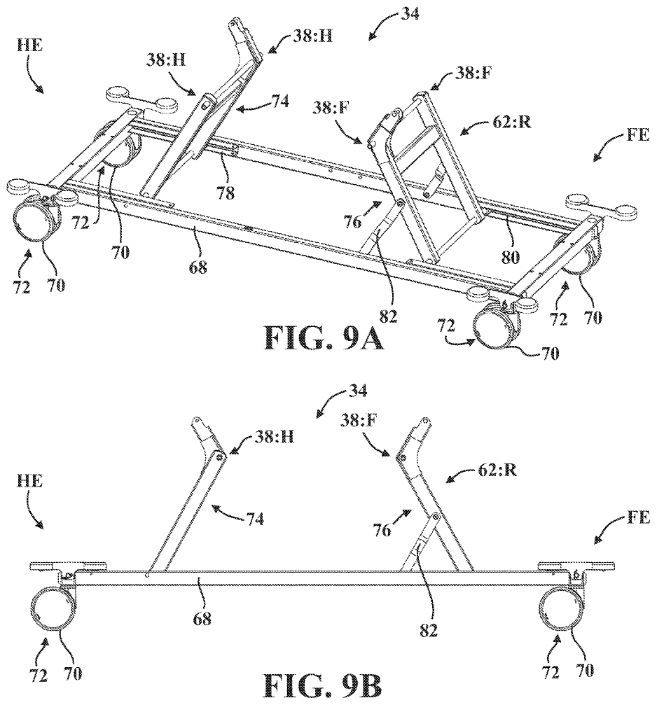

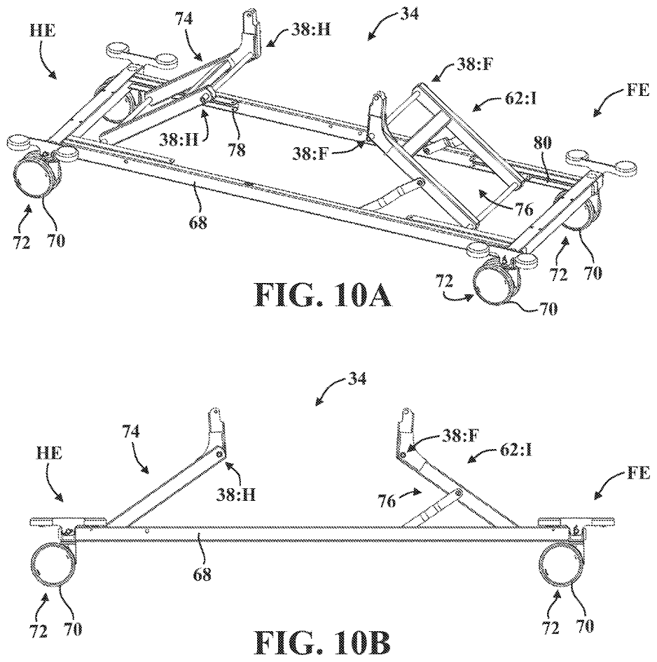

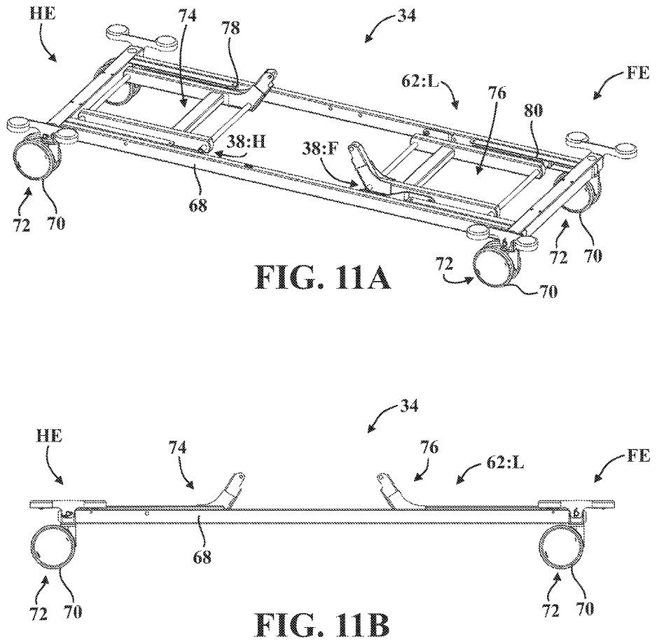

The base assembly 34 further includes the litter support coupler 38 (described below) and a lift mechanism 62. The lift mechanism 62 extends between the base assembly 34 and the litter support coupler 38. The lift mechanism 62 operates to lift and lower the litter support coupler 38 relative to the base frame 68. The lift mechanism 62 is configured to move the litter support coupler 38 between a plurality of vertical configurations relative to the base frame 68, or to any desired position in between. For example, FIGS. 9A and 9B show the lift mechanism 62 in a raised configuration R. FIGS. 10A and 10B show the lift mechanism 62 in an intermediate configuration I. FIGS. 11A and 11B show the lift mechanism 62 in a lowered configuration L. Any suitable lift mechanism 62 capable of moving the litter support coupler 38 between a plurality of vertical configurations relative to the base frame 68 is contemplated.

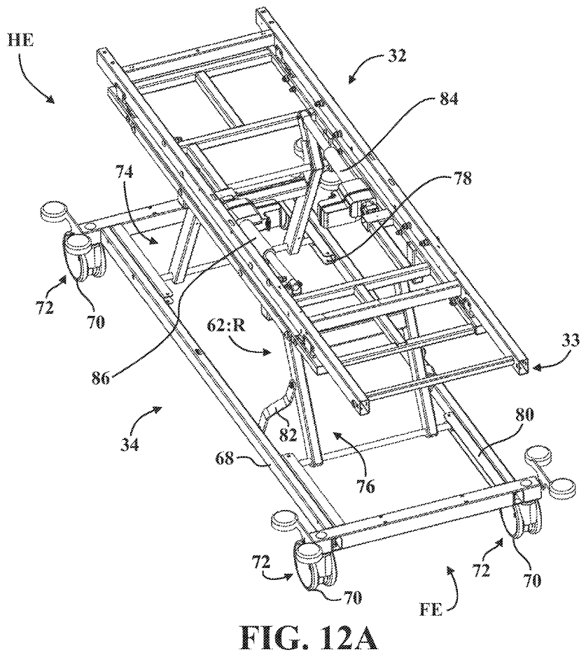

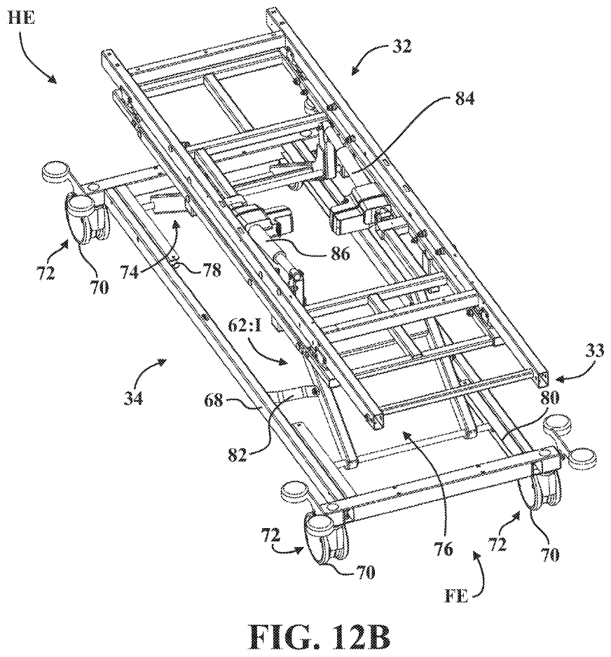

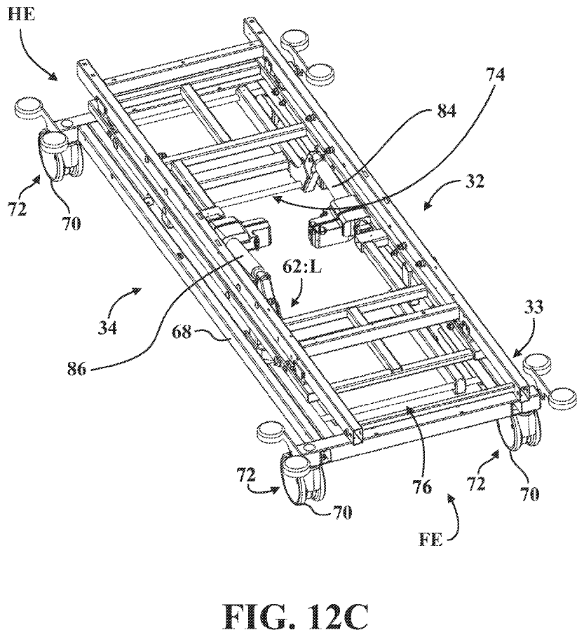

With continued reference to FIGS. 9A-12C, in some configurations, the lift mechanism 62 includes a head end lift subassembly 74 arranged to lift or lower the litter assembly 32 relative to the head end HE of the base assembly 34, and a foot end lift subassembly 76 arranged to lift or lower the litter assembly 32 relative to the foot end FE of the base assembly 34. Actuators (described in further detail below and best shown in FIGS. 12A-12C) may be operatively attached to one or both of the head end lift subassembly 74 and the foot end lift subassembly 76 to actuate the lift mechanism 62. The head end lift subassembly 74 and the foot end lift subassembly 76 may be separately and independently operable such that litter support couplers 38 can be placed in a variety of patient positions to move the litter assembly 32 to a variety of positions (such as a Trendelenburg position) in which the head end HE of the litter assembly 32 and the foot end FE of the litter assembly 32 are at different heights relative to the base frame 68.

Still referring to FIGS. 9A-12C, the head end lift subassembly 74 may be operatively attached to the head end HE of the base frame 68. For example, in some configurations, base frame 68 defines a head end channel 78 configured to receive the head end lift subassembly 74 and guide the head end lift subassembly 74 longitudinally along the base frame 68 as the head end lift subassembly 74 moves relative to the head end HE the base frame 68 (see the sequence of FIGS. 9A-11B). Additionally, in some configurations, the lift mechanism 62 may further include a head end timing linkage 81 (shown in FIGS. 3A and 3B) extending between the head end lift subassembly 74 and the base frame 68 to coordinate motion of the head end lift subassembly 74 relative to the base frame 68. Similarly, the foot end lift subassembly 76 may be operatively attached to the foot end FE of the base frame 68. For example, in some configurations, base frame 68 defines a foot end channel 80 configured to receive the foot end lift subassembly 76 and guide the foot end lift subassembly 76 longitudinally along the base frame 68 as the foot end lift subassembly 76 moves relative to the foot end of the base frame 68 (see the sequence of FIGS. 9A-11B). Also similarly, the lift mechanism 62 may further include a foot end timing linkage 82 extending between the foot end lift subassembly 76 and the base frame 68 to coordinate motion of the foot end lift subassembly 76 relative to the base frame 68.

Additionally, in some configurations, the head end lift subassembly 74 and the foot end lift subassembly 76 may be the same form as each other, or may have different respective forms. For instance, one of the head end lift subassembly 74 and the foot end lift subassembly 76 may be a crank-type mechanism or scissor-type mechanism, while the other of the head end lift subassembly 74 and the foot end lift subassembly 76 may be a column lift. The column lifts may be hydraulic jacks capable of extending and retracting. The column lifts may be like those described in U.S. Pat. No. 6,820,294, entitled “Linkage for Lift/Lowering Control for A Patient Supporting Platform,” filed on Feb. 26, 2002, hereby incorporated herein by reference, or like those described in U.S. Pat. No. 7,395,564, entitled “Articulated Support Surface for A Stretcher or Gurney,” filed on Mar. 24, 2006, hereby incorporated herein by reference. Another lift mechanism 62 is shown in U.S. Provisional Patent Application No. 62/948,540 , filed on Dec. 16, 2019, entitled “Patient Support with Lift Assembly,” which is hereby incorporated herein by reference.

The actuators of the lift mechanism 62 may include linear actuators, rotary actuators, or other types of actuators. The actuators may be electrically operated, hydraulic, electro-hydraulic, pneumatic, or the like. The actuators may include motors, gear trains, drive screws, nuts/lead screws, and the like, for actuation. The actuators may be arranged at any suitable location to actuate the lifts. For example, referring to FIGS. 12A-12C, the lift mechanism 62 may include a head end actuator 84 operatively attached to the litter assembly 32 and the head end lift subassembly 74 to raise and lower the head end lift subassembly 74 relative to the base frame 68 (see the sequence of FIGS. 12A to 12C). Likewise, the lift mechanism 62 may further include a foot end actuator 86 operatively attached to the litter assembly 32 and the foot end lift subassembly 76 to raise and lower the foot end lift subassembly 76 relative to the base frame 68 (see the Sequence of FIGS. 12a to 12c).

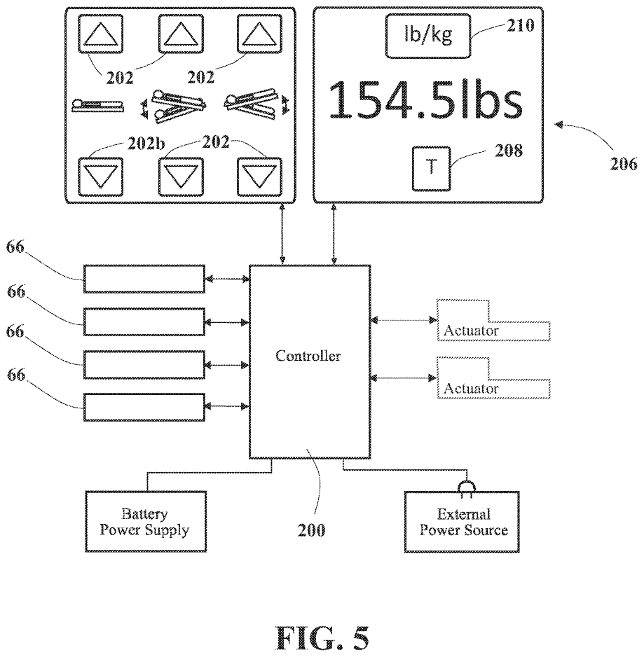

Referring to back to FIG. 5, a control system with a controller 200 is shown. The controller 200 may have one or more processors for processing instructions or for processing algorithms stored in memory to control operation of the actuators to coordinate movement of the actuators of the lift mechanism 62 and/or patient support deck 42 to evenly lift and lower the litter assembly 32 relative to the base assembly 34 and/or adjust the patient support deck 42 relative to the litter assembly 32 (and/or other portions of the patient support apparatus 36 such as the base assembly 34), and/or to independently operate actuators to place the litter assembly 32 in a variety of patient positions such as a Trendelenburg position in which the head end and the foot end are at different heights relative to the base assembly 34. Additionally or alternatively, the controller 200 may include one or more microcontrollers, microprocessors, field programmable gate arrays, systems on a chip, discrete circuitry, and/or other suitable hardware, software, or firmware that is capable of carrying out the functions described herein. The controller 200 may be carried on-board the patient support apparatus 36 or may be remotely located. In some versions, the controller 200 is mounted to the base assembly 34. In some versions, the controller 200 is mounted to the footboard 58. Power to the actuators and/or the controller 200 may be provided by a battery power supply and/or an external power source.

The controller 200 is coupled to the actuators in a manner that allows the controller 200 to control the actuators. The controller 200 may communicate with the actuators via wired or wireless connections to perform one of more desired functions. The controller 200 may monitor a current state of the actuators via one or more sensors and determine desired states in which the actuators should be placed, based on one or more input signals that the controller 200 receives from one or more user input devices. The state of the actuators may be a position, a relative position, an angle, an energization status (e.g., on/off), or any other parameter of the actuators.

A user, such as a caregiver, may actuate one or more user input devices 202, which transmit corresponding input signals to the controller 200, and the controller 200 controls operation of the actuators based on the input signals. The user input devices 202 may include any device capable of being actuated by the user and may be provided on a control panel, touchscreen, or the like. The user input devices 202 may be configured to be actuated in a variety of different ways, including but not limited to, mechanical actuation (hand, foot, finger, etc.), hands-free actuation (voice, foot, etc.), and the like. The user input devices 202 may include buttons (such as buttons corresponding to lift, lower, normal Trendelenburg, and reverse Trendelenburg), a gesture sensing device for monitoring motion of hands, feet, or other body parts of the user (such as through a camera), a microphone for receiving voice activation commands, a foot pedal, and sensors (e.g., infrared sensor such as a light bar or light beam to sense a user's body part, ultrasonic sensors, capacitive sensors, etc.). Additionally, the buttons/pedals can be physical buttons/pedals or virtually implemented buttons/pedals such as through optical projection or on a touchscreen. The buttons/pedals may also be mechanically connected or drive-by-wire type buttons/pedals where a user applied force actuates a sensor, such as a switch or potentiometer. It should be appreciated that any combination of user input devices may also be utilized. The user input devices may be located on one of the side rails 48, 50, 52, 54, the headboard 56, the footboard 58, or other suitable locations. The user input devices may also be located on a portable electronic device (e.g., iWatch®, iPhone®, iPad®, or similar electronic devices). Other configurations are contemplated.

The control system may also include or otherwise facilitate operation of the weigh system to indicate a patient's weight and/or to detect a patient's position/movement on the patient support apparatus 36, such as in conjunction with a bed exit (or pre-exit detection) alert system. In some versions, the scale includes the load cell assemblies 66 connected to the controller 200 to provide signals associated with loads measured by each of the load cell assemblies 66. For example, each load cell assembly 66 may include a pair of activation leads and a pair of sensor leads. The controller 200 may include a circuit in electrical communication with the activation leads to supply electrical power to the load cell assembly 66 via one of the activation leads with the other activation lead coupled to ground. The controller 200 may be in electrical communication with the sensor leads that provide output to the controller 200, wherein the output correlates to how much force is being exerted on the load cell assemblies 66. See, for example, the description of load cells in U.S. patent application Ser. No. 16/549,612, entitled “Angle Calibration Using Load Cells,” filed Aug. 23, 2019, hereby incorporated herein by reference.

The output signals received from the load cell assemblies 66 via their sensor leads are collectively processed by the controller 200 using scale algorithms to determine, for example, a patient's weight to output to a display 206, as shown in FIG. 5. See, for example, the methods described in U.S. patent application Ser. No. 16/549,612, entitled “Angle Calibration Using Load Cells,” incorporated by reference herein. The scale may include a tare function 208 and a converter 210 to switch between kilograms and pounds.

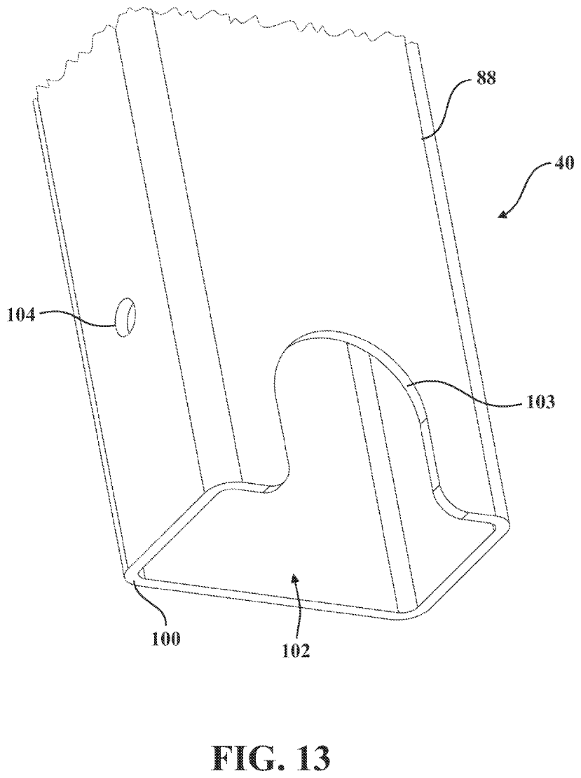

FIGS. 13-17 illustrate coupling the litter assembly 32 to the base assembly 34. More particularly, FIGS. 13-17 illustrate coupling the litter support receiver 40 to the litter support coupler 38 to couple the litter assembly 32 to the base assembly 34. It should be appreciated that in the context of FIGS. 13-17, reference to the litter support receiver 40 includes either the first litter support receiver 40A of the first litter assembly 32A or the second litter support receiver 40B of the second litter assembly 32B. It should also be appreciated that the litter assembly 32 (either the first litter assembly 32A or the second litter assembly 32B) may include more than one litter support receiver 40 and the base assembly 34 may include more than one litter support coupler 38. For example, as best shown in FIGS. 9A-11B, the litter support coupler 38 may be further defined as a head end litter support coupler 38H operatively attached to the head end lift subassembly 74, and a foot end litter support coupler 38F operatively attached to the foot end lift subassembly 76. Accordingly, as best shown in FIGS. 6A-7B, the litter support receiver 40 of the litter assembly 32 may be further defined as a head end litter support receiver 40H and a foot end litter support receiver 40F. The head end litter support receiver 40H may be configured to engage the head end litter support coupler 38H to couple the head end HE of the litter assembly 32 to the head end HE of the base assembly 34 (best shown in FIGS. 3A and 3B). Likewise, the foot end litter support receiver 40F may be configured to engage the foot end litter support coupler 38F to couple the foot end FE of the litter assembly 32 to the foot end FE of the base assembly 34.

Additionally, in some configurations, the head end litter support receiver 40H may be further defined as a pair of head end litter support receivers 40H spaced laterally from each other, and the head end litter support coupler 38H is further defined as a pair of head end litter support couplers 38H spaced laterally from each other (best shown in FIGS. 9A-11B). Accordingly, the pair of head end litter support receivers 40H may be configured to engage the pair of head end litter support couplers 38 to couple the litter assembly 32 to the base assembly 34. Likewise, the foot end litter support receiver 40F may be further defined as a pair of foot end litter support receivers 40F spaced laterally from each other, and the foot end litter support coupler 38 may be further defined as a pair of foot end litter support couplers 38F spaced laterally from each other. Similarly, the pair of foot end litter support receivers 40F may be configured to engage the pair of foot end litter support couplers 38F to couple the litter assembly 32 to the base assembly 34.

Referring to FIG. 13, the litter support receiver 40 includes a litter support brace 88. The litter support brace 88 is operatively attached to the litter support structure 33 (either the first litter support structure 33A or the second litter support structure 33B). For example, the litter support brace 88 may extend downward from the intermediate frame 44 (as shown in FIGS. 6A and 6B) or extend downward from the weigh frame 64 (as shown in FIGS. 7A and 7B).

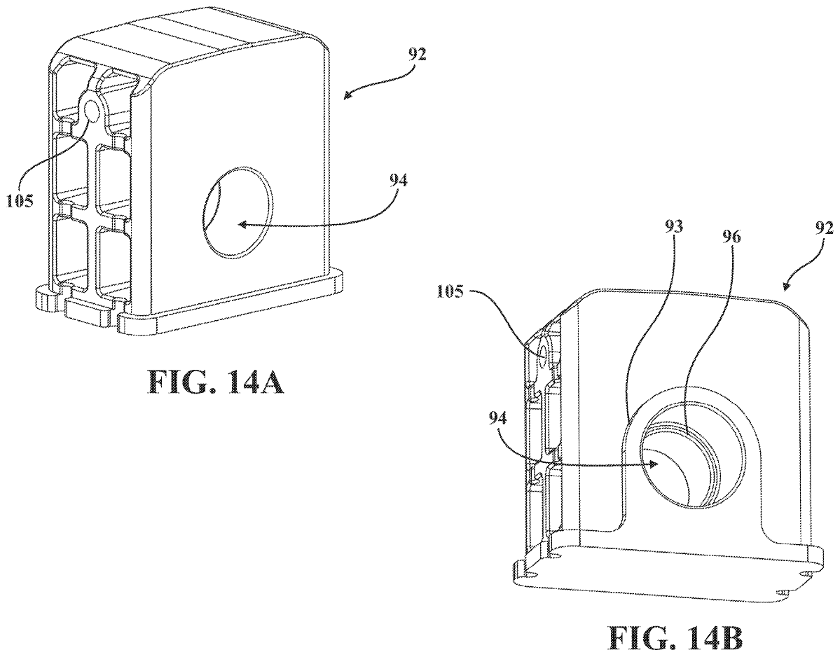

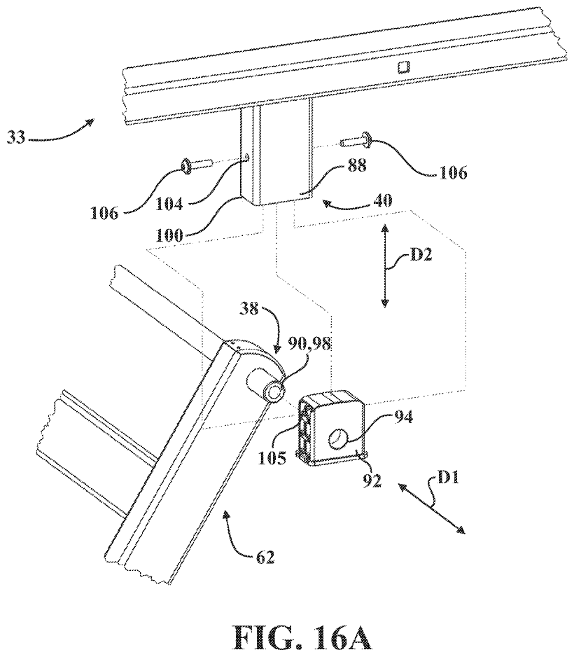

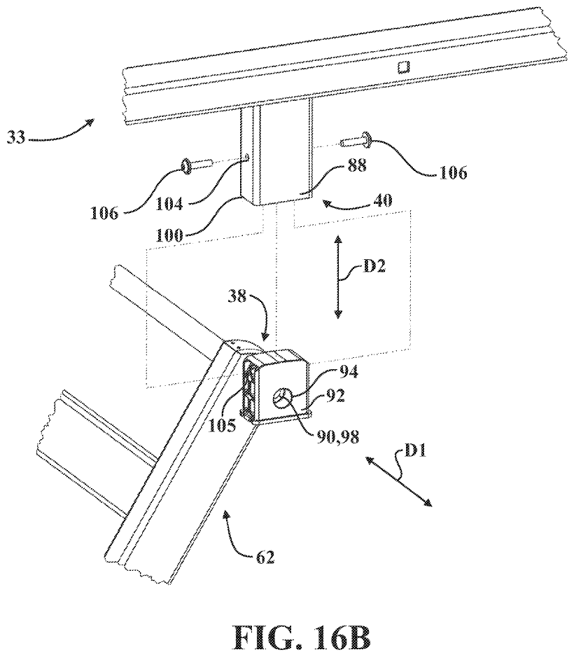

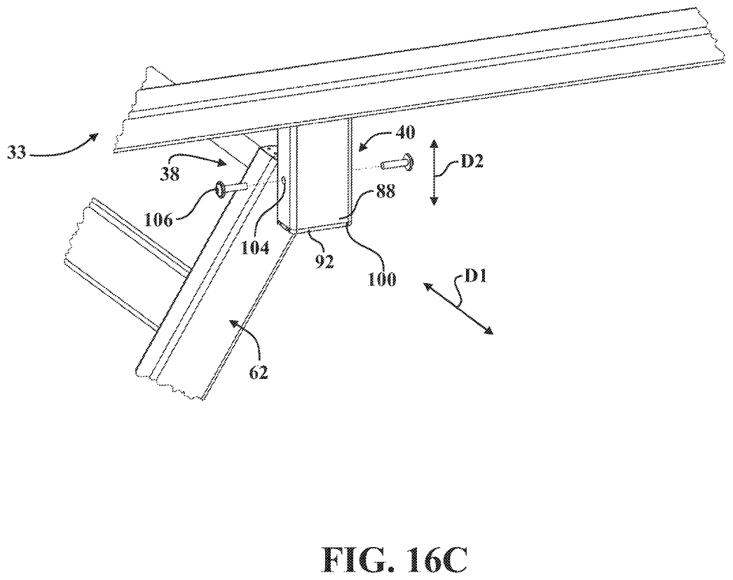

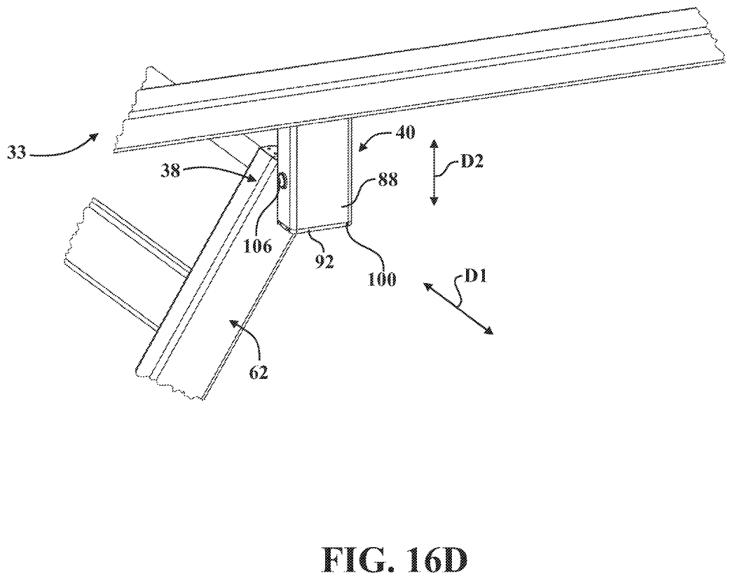

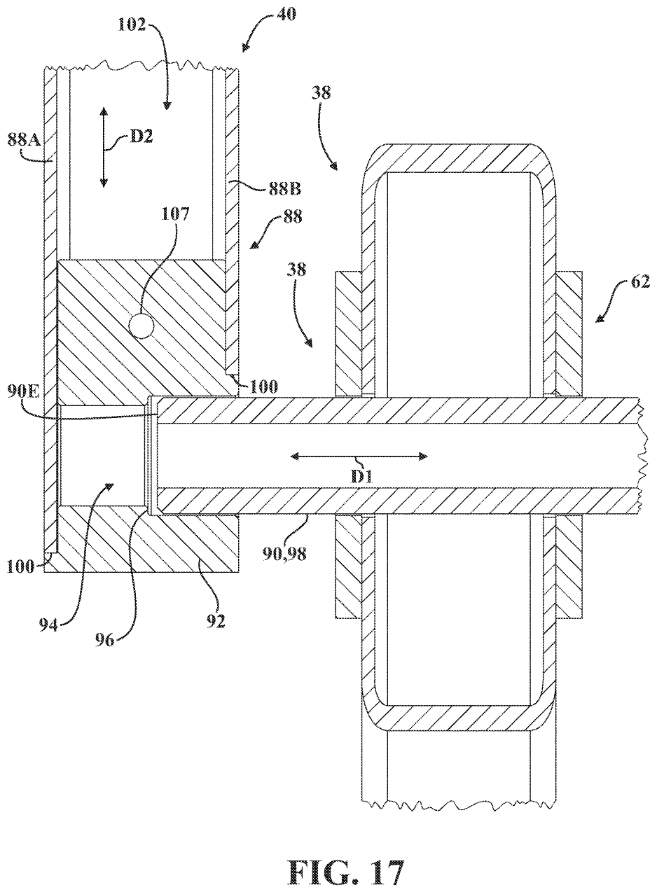

As best shown in FIG. 16A, the litter support coupler 38 may include a mounting member 90. Referring now to FIGS. 14A and 14B, the modular patient support system 30 may further include a litter support adapter 92. The litter support adapter 92 may be used to couple the litter support receiver 40 to the litter support coupler 38 to couple the litter assembly 32 to the base assembly 34 to form the patient support apparatus 36. In some configurations, the litter support adapter 92 may define an adapter void 94 shaped for engagement with the mounting member 90 to couple the litter support adapter 92 to the litter support coupler 38. As best shown in FIG. 17, the adapter void may define a step 96 to laterally constrain movement of the mounting member 90 within the adapter void 94. In some examples, the mounting member 90 may be a mounting shaft 98 that is round. Accordingly, the adapter void 94 may be shaped to correspond to the mounting shaft 98 such that the litter support adapter 92 is coupled to the litter support coupler 38 for pivoting movement relative to the litter support coupler 38. Other arrangements for enabling pivoting movement of the litter support adapter 92 relative to the litter support coupler 38 are contemplated. For example, either of the litter support adapter 92 and the litter supper coupler 38 may include a bearing, bushing or the like to permit pivoting movement of the litter support adapter 92 relative to the litter support coupler 38.

Referring back to FIG. 13, the litter support brace 88 may extend to a brace end 100. In some examples, the brace end 100 of the litter support brace 88 defines a brace void 102. The brace void 102 may be shaped to receive the litter support adapter 92 to couple the litter support brace 88 to the litter support adapter 92. Additionally, the litter support brace 88 may define one or more coupling voids 104 and the litter support adapter 92 may define one or more corresponding voids 105 configured to receive fasteners 106 such that the fasteners 106 engage the litter support adapter 92 to limit movement of the litter support brace 88 relative to the litter support adapter 92. As a result, the litter support receiver 40 is coupled to the litter support coupler 38, thereby coupling the litter assembly 32 to the base assembly 34. Further, in some examples, the litter support adapter 92 may define an alignment ridge 93 and the brace void 102 may define an alignment recess 103 that is configured to receive the alignment ridge 93 to align the litter support adapter 92 within the brace void 102.

FIG. 17 shows an example cross-sectional representation of the litter support receiver coupled to the litter support coupler 38. In this example, the mounting member 90 extends laterally from the lift mechanism 62, and the mounting member 90 includes an end 90E that is laterally engaged in a first direction D1 with the adapter void 94 of the litter support adapter 92 to couple the litter support adapter 92 to the mounting member 90. Also in this example, the litter support brace 88 includes opposing walls 88A and 88B that are spaced to define the brace void 102. The litter support adapter 92 engaged with the brace void in a second direction D2 that is transverse with the first direction D1. As a result, the litter support receiver 40 is coupled to the litter support coupler 38, thereby coupling the litter assembly 32 to the base assembly 34.

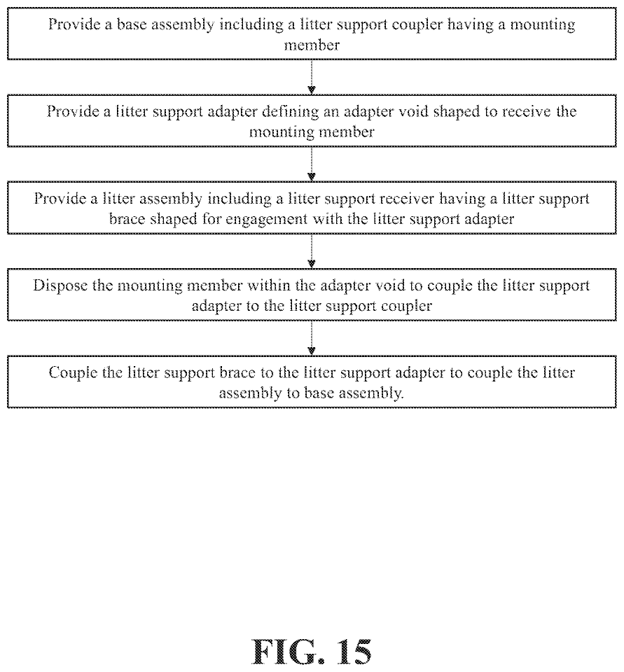

Referring back to FIG. 15, the present disclose includes another method of assembling the patient support apparatus 36. Particularly, the method relates to coupling the litter assembly 32 to the base assembly 34 to form the patient support apparatus 36. The method includes steps of providing the base assembly 34 including the litter support coupler 38 having the mounting member 90, providing the litter support adapter 92 defining the adapter void 94 shaped to receive the mounting member 90, and providing the litter assembly 32 including the litter support receiver 40 having the litter support brace 88 shaped for engagement with the litter support adapter 92. As best shown in the transition from FIGS. 16A to 16B, the method also includes disposing the mounting member 90 within the adapter void 94 to couple the litter support adapter 92 to the litter support coupler 38. For example, disposing the mounting member 90 within the adapter void 94 may include inserting the mounting member 90 into the adapter void 94 in a lateral direction (i.e., first direction D1). Referring to the transition from FIGS. 16B to 16C, the method further includes coupling the litter support brace 88 to the litter support adapter 92 to couple the litter assembly 32 to the base assembly 34. For example, coupling the litter support brace 88 to the litter support adapter 92 may include inserting the litter support adapter into the brace void 102 in a direction transverse to the lateral direction (i.e., the second direction D2). Additionally, in some examples, referring to the transition between FIGS. 16C and 16D, the method may further include disposing fastener 106 through the one or more coupling voids 104 to limit movement of the litter support brace 88 relative to the litter support adapter 92. Accordingly, the method couples the litter support receiver 40 to the litter support coupler 38, thereby coupling the litter assembly 32 to the base assembly 34.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A modular patient support system comprising:
a litter assembly including one of:
   a first litter support structure having a first configuration and a first litter support receiver operatively attached to the first litter support structure, and
   a second litter support structure having a second configuration, different than the first configuration, and a second litter support receiver operatively attached to the second litter support structure; and
a base assembly including:
   A base frame,
   a litter support coupler configured to engage one of the first litter support receiver and the second litter support receiver to couple the litter assembly to the base assembly, and
   a lift mechanism extending between the base frame and the litter support coupler, the lift mechanism configured to move the litter support coupler between a plurality of vertical configurations relative to the base frame.
      II. The modular patient support system of clause I, wherein the first litter support structure comprises:
a first intermediate frame; and
a first patient support deck operatively attached the first intermediate frame, the first patient support deck defining a first patient support surface for supporting a patient;
wherein the first litter support receiver is operatively attached to the first intermediate frame to engage the litter support coupler to couple the litter assembly to the base assembly.
   III. The modular patient support system of any of clauses I-II, wherein the second litter support structure comprises:
A weigh frame;
a second intermediate frame spaced above and operatively attached to the weigh frame; and
a second patient support deck operatively attached the second intermediate frame, the second patient support deck defining a second patient support surface for supporting a patient;
wherein the second litter support receiver is operatively attached to the weigh frame to engage the litter support coupler to couple the litter assembly to the base assembly.
   IV. The modular patient support system of clause III, wherein the second litter support structure further comprises a plurality of load cell assemblies interposed between the second intermediate frame and the weigh frame to measure load about the second patient support surface.
   V. The modular patient support system of any of clauses I-V, wherein:
the base frame extends between a head end and a foot end;
the lift mechanism includes a head end lift subassembly operatively attached to the head end of the base frame and a foot end lift subassembly operatively attached to the foot end of the base frame; and
the litter support coupler is further defined as:
   a head end litter support coupler operatively attached to the head end lift subassembly, and
   a foot end litter support coupler operatively attached to the foot end lift subassembly.
      VI. The modular patient support system of clause V, wherein the lift mechanism further comprises a head end actuator operatively attached to the litter assembly and the head end lift subassembly to raise and lower the head end lift subassembly relative to the base frame.
      VII. The modular patient support system of any of clauses V-VI, wherein the base frame defines a head end channel configured to receive the head end lift subassembly and guide the head end lift subassembly longitudinally along the base frame as the head end lift subassembly moves relative to the base frame.
      VIII. The modular patient support system of any of clauses V-VII, wherein the lift mechanism further comprises a foot end actuator operatively attached to the litter assembly and the foot end lift subassembly to raise and lower the foot end lift subassembly relative to the base frame.
      IX. The modular patient support system of any of clauses V-VIII, wherein the base frame defines a foot end channel configured to receive the foot end lift subassembly and guide the foot end lift subassembly longitudinally along the base frame as the foot end lift subassembly moves relative to the base frame.
      X. The modular patient support system of any of clauses V-IX, wherein the lift mechanism further comprises a head end timing linkage extending between the head end lift subassembly and the base frame to coordinate motion of the head end lift subassembly relative to the base frame.
      XI. The modular patient support system of any of clauses V-X, wherein the lift mechanism further comprises a foot end timing linkage extending between the foot end lift subassembly and the base frame to coordinate motion of the foot end lift subassembly relative to the base frame.
      XII. The modular patient support system of any of clauses V-XI, wherein the first litter support receiver is further defined as:
a first head end litter support receiver configured to engage the head end litter support coupler to couple the litter assembly to the base assembly; and
a first foot end litter support receiver configured to engage the foot end litter support coupler to couple the litter assembly to the base assembly.
   XIII. The modular patient support system of clause XII, wherein:
the first head end litter support receiver is further defined as a pair of first head end litter support receivers spaced laterally from each other;
the head end litter support coupler is further defined as a pair of head end litter support couplers spaced laterally from each other; and
the pair of first head end litter support receivers are configured to engage the pair of head end litter support couplers to couple the litter assembly to the base assembly.
   XIV. The modular patient support system of any of clauses XII-XIII, wherein:
the first foot end litter support receiver is further defined as a pair of first foot end litter support receivers spaced laterally from each other;
the foot end litter support coupler is further defined as a pair of foot end litter support couplers spaced laterally from each other; and
the pair of first foot end litter support receivers are configured to engage the pair of foot end litter support couplers to couple the litter assembly to the base assembly.
   XV. The modular patient support system of any of clauses V-XIV, wherein the second litter support receiver is further defined as:
a second head end litter support receiver configured to engage the head end litter support coupler to couple the litter assembly to the base assembly; and
a second foot end litter support receiver configured to engage the foot end litter support coupler to couple the litter assembly to the base assembly.
   XVI. The modular patient support system of clause XV, wherein:
the second head end litter support receiver is further defined as a pair of second head end litter support receivers spaced laterally from each other;
the head end litter support coupler is further defined as a pair of head end litter support couplers spaced laterally from each other; and
the pair of second head end litter support receivers are configured to engage the pair of head end litter support couplers to couple to couple the litter assembly to the base assembly.
   XVII. The modular patient support system of any of clauses XV-XVI, wherein:
the second foot end litter support receiver is further defined as a pair of second foot end litter support receivers spaced laterally from each other;
the foot end litter support coupler is further defined as a pair of foot end litter support couplers spaced laterally from each other; and
the pair of second foot end litter support receivers are configured to engage the pair of foot end litter support couplers to couple to couple the litter assembly to the base assembly.
   XVIII. The modular patient support system of any of clauses I-XVII, wherein:
the modular patient support system further comprises a litter support adapter engaged with the litter support coupler;
the first litter support receiver comprises a first litter support brace operatively attached to the first litter support structure and shaped for engagement with the litter support adapter to couple the first litter support structure to the base assembly; and
the second litter support receiver comprises a second litter support brace operatively attached to the second litter support structure and shaped for engagement with the litter support adapter to couple the second litter support structure to the base assembly.
   XIX. The modular patient support system of clause XVIII, wherein:
the litter support coupler includes a mounting member extending laterally from the lift mechanism; and
the litter support adapter defines an adapter void shaped for engagement with the mounting member to couple the litter support adapter to the litter support coupler.
   XX. The modular patient support system of any of clauses I-XIX, wherein the first litter support structure does not include a weigh system, and the second litter support structure includes a weigh system.
   XXI. A patient support apparatus comprising:
a base assembly including:
   a base frame;
   a litter support coupler including a mounting member; and
   a lift mechanism extending between the base frame and the litter support coupler,
      the lift mechanism configured to move the litter support coupler between a plurality of vertical configurations relative to the base frame;
a litter support adapter engaged with the mounting member; and
a litter assembly including:
   a litter support structure; and
   a litter support receiver for coupling the litter assembly to the base assembly, the litter support receiver including a litter support brace operatively attached to the litter support structure and shaped for engagement with the litter support adapter to couple the litter assembly to the base assembly.
      XXII. The patient support apparatus of clause XXI, wherein the litter support adapter defines an adapter void configured to engage the mounting member to couple the litter support adapter to the litter support coupler.
      XXIII. The patient support apparatus of clause XXII, wherein the adapter void defines a step to laterally constrain movement of the mounting member within the adapter void.
      XXIV. The patient support apparatus of any of clauses XXII-XXIII, wherein the mounting member defines a mounting shaft shaped for engagement with the adapter void to couple the litter support adapter to the litter support coupler for pivoting movement relative to the litter support coupler.
      XXV. The patient support apparatus of any of clauses XXII-XXIV, wherein the litter support brace extends from the litter support structure to a brace end and is coupled to the litter support adapter to couple the litter assembly to the base assembly.
      XXVI. The patient support apparatus of clause XXV, wherein the litter support brace defines a brace void formed in the brace end and shaped to receive the litter support adapter to couple the litter support brace to the litter support adapter.
      XXVII. The patient support apparatus of clause XXVI, wherein the litter support brace defines a coupling void configured to receive a fastener to limit movement of the litter support brace relative to the litter support adapter.
      XXVIII. The patient support apparatus of any of clauses XXI-XXVII, wherein the litter support structure does not include a weigh system.
      XXIX. The patient support apparatus of any of clauses XXI-XXVIII, wherein the litter support structure includes a weigh system.
      XXX. The patient support apparatus of any of clauses XXI-XXIX, wherein the litter support structure comprises:
an intermediate frame; and
a patient support deck operatively attached the intermediate frame, the patient support deck defining a patient support surface for supporting a patient;
wherein the litter support brace is operatively attached to the intermediate frame.
   XXXI. The patient support apparatus of any of clauses XXI-XXX, wherein the litter support structure comprises:
a weigh frame;
an intermediate frame spaced above and operatively attached to the weigh frame; and
a patient support deck operatively attached the intermediate frame, the patient support deck defining a patient support surface for supporting a patient;
wherein the litter support brace is operatively attached to the weigh frame.
   XXXII. The patient support apparatus of clause XXXI, wherein the litter support structure further comprises a plurality of load cell assemblies interposed between the intermediate frame and the weigh frame to measure load about the patient support surface.
   XXXIII. The patient support apparatus of any of clauses XXI-XXXII, wherein:
the base assembly extends between a head end and a foot end;
the lift mechanism includes a head end lift subassembly and a foot end lift subassembly; and
the litter support coupler is further defined as:
   a head end litter support coupler operatively attached to the head end lift subassembly, and
   a foot end litter support coupler operatively attached to the foot end lift subassembly.
      XXXIV. The patient support apparatus of clause XXXIII, wherein the lift mechanism further comprises a head end actuator operatively attached to the litter assembly and the head end lift subassembly to raise and lower the head end lift subassembly relative to the base frame.
      XXXV. The patient support apparatus of any of clauses X XIII-XXXIV, wherein the base frame defines a head end channel configured to receive the head end lift subassembly and guide the head end lift subassembly longitudinally along the base frame as the head end lift subassembly moves relative to the base frame.
      XXXVI. The patient support apparatus of any of clauses XXXIII-XXXV, wherein the lift mechanism further comprises a foot end actuator operatively attached to the litter assembly and the foot end lift subassembly to raise and lower the foot end lift subassembly relative to the base frame.
      XXXVII. The patient support apparatus of any of clauses XXXIII-XXXVI, wherein the base frame defines a foot end channel configured to receive the foot end lift subassembly and guide the foot end lift subassembly longitudinally along the base frame as the foot end lift subassembly moves relative to the base frame.
      XXXVIII. The patient support apparatus of any of clauses XXXIII-XXXVII, wherein the lift mechanism further comprises a timing linkage extending between the head end lift subassembly and the base frame to coordinate motion of the head end lift subassembly relative to the base frame.
      XXXIX. The patient support apparatus of any of clauses XXXIII-XXXVIII, wherein the lift mechanism further comprises a timing linkage extending between the foot end lift subassembly and the base frame to coordinate motion of the foot end lift subassembly relative to the base frame.
      XL. The patient support apparatus of any of clauses XIII-XXXIX, wherein the litter support receiver is further defined as:
a head end litter support receiver configured to engage the head end litter support coupler to couple the litter assembly to the base assembly; and
a foot end litter support receiver configured to engage the foot end litter support coupler to couple the litter assembly to the base assembly.
   XLI. The patient support apparatus of clause XL, wherein:
the head end litter support receiver is further defined as a pair of head end litter support receivers spaced laterally from each other;
the head end litter support coupler is further defined as a pair of head end litter support couplers spaced laterally from each other; and
the pair of head end litter support receivers are configured to engage the pair of head end litter support couplers to couple the litter assembly to the base assembly.
   XLII. The patient support apparatus of any of clauses XL-XLI, wherein:
the foot end litter support receiver is further defined as a pair of foot end litter support receivers spaced laterally from each other;
the foot end litter support coupler is further defined as a pair of foot end litter support couplers spaced laterally from each other; and
the pair of foot end litter support receivers are configured to engage the pair of foot end litter support couplers to couple the litter assembly to the base assembly.
   XLIII. A method of assembling a patient support apparatus comprising:
(a) providing a base assembly including a litter support coupler;
(b) selecting one of:
   a first litter assembly including a first litter support structure having a first configuration and a first litter support receiver, and
   a second litter assembly including a second litter support structure having a second configuration, different from the first configuration, and a second litter support receiver; and
(c) coupling the litter support receiver of the litter assembly selected in step (b) to the litter support coupler to couple the litter assembly selected in step (b) to the base assembly.
   XLIV. The method of clause XLIII, wherein the litter support coupler comprises a mounting member extending laterally from the base assembly.
   XLV. The method of clause XLIV, wherein the method further comprises:
providing a litter support adapter defining an adapter void shaped to receive the mounting member; and
disposing the mounting member within the adapter void to couple the litter support adapter to the litter support coupler.
   XLVI. The method of clause XLV, wherein disposing the mounting member within the adapter void further comprises inserting the mounting member into the adapter void in a lateral direction.
   XLVII. The method of clause XLVI, wherein the first litter support receiver further comprises a first litter support brace operatively attached to the first litter support structure, and the method further comprises coupling the first litter support brace to the litter support adapter to couple the first litter support structure to the base assembly.
   XLVIII. The method of clause XLVII, wherein the first litter support brace defines a first brace void, and coupling the first litter support brace to the litter support adapter further comprises inserting the litter support adapter into the first brace void in a direction transverse to the lateral direction.
   XLIX. The method of any of clauses XLVI-XLVIII, wherein the second litter support receiver further comprises a second litter support brace operatively attached to the second litter support structure, and the method further comprises coupling the second litter support brace to the litter support adapter to couple the second litter support structure to the base assembly.
   L. The method of clause XLIX, wherein the second litter support brace defines a second brace void, and coupling the second litter support brace to the litter support adapter further comprises inserting the litter support adapter into the second brace void in a direction transverse to the lateral direction.
   LI. The method of any of clauses XLIII-L, wherein the first litter support structure comprises:
a first intermediate frame; and
a first patient support deck operatively attached the first intermediate frame, the first patient support deck defining a first patient support surface for supporting a patient;
wherein the first litter support receiver is operatively attached to the first intermediate frame to engage the litter support coupler to couple the first litter assembly to the base assembly.
   LII. The method of any of clauses XLIII-LI, wherein the second litter support structure comprises:
a weigh frame;
a second intermediate frame spaced above and operatively attached to the weigh frame; and
a second patient support deck operatively attached the second intermediate frame, the second patient support deck defining a second patient support surface for supporting a patient;
wherein the second litter support receiver is operatively attached to the weigh frame to engage the litter support coupler to couple the second litter assembly to the base assembly.
   LIII. A method of assembling a patient support apparatus comprising:
providing a base assembly including a litter support coupler having a mounting member;
providing a litter support adapter defining an adapter void shaped to receive the mounting member;
providing a litter assembly including a litter support receiver having a litter support brace shaped for engagement with the litter support adapter;
disposing the mounting member within the adapter void to couple the litter support adapter to the litter support coupler; and
coupling the litter support brace to the litter support adapter to couple the litter assembly to the base assembly.
   LIV. The method of clause LIII, wherein:
the mounting member extends laterally from the base assembly; and
disposing the mounting member within the adapter void further comprises inserting the mounting member into the adapter void in a lateral direction.
   LV. The method of clause LIV, wherein the litter support brace defines a brace void, and coupling the litter support brace to the litter support adapter further comprises inserting the litter support adapter into the brace void in a direction transverse to the lateral direction.
   LVI. The method of clause LV, wherein:
the litter support brace defines a coupling void; and
coupling the litter support brace to the litter support adapter further comprises disposing a fastener through the coupling void to limit movement of the litter support brace relative to the litter support adapter.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A patient support apparatus comprising:
a base assembly including:
a base frame;
a litter support coupler including a mounting member; and
a lift mechanism extending between the base frame and the litter support coupler,
the lift mechanism configured to move the litter support coupler between a plurality of vertical configurations relative to the base frame;
a litter support adapter engaged with the mounting member; and
a litter assembly including:
a litter support structure; and
a litter support receiver for coupling the litter assembly to the base assembly, the litter support receiver including a litter support brace operatively attached to the litter support structure and shaped for engagement with the litter support adapter to couple the litter assembly to the base assembly.

22. The patient support apparatus of claim 21, wherein the litter support adapter defines an adapter void configured to engage the mounting member to couple the litter support adapter to the litter support coupler.

23. The patient support apparatus of claim 22, wherein the adapter void defines a step to laterally constrain movement of the mounting member within the adapter void.

24. The patient support apparatus of claim 22, wherein the mounting member defines a mounting shaft shaped for engagement with the adapter void to couple the litter support adapter to the litter support coupler for pivoting movement relative to the litter support coupler.

25. The patient support apparatus of claim 22, wherein the litter support brace extends from the litter support structure to a brace end and is coupled to the litter support adapter to couple the litter assembly to the base assembly.

26. The patient support apparatus of claim 25, wherein the litter support brace defines a brace void formed in the brace end and shaped to receive the litter support adapter to couple the litter support brace to the litter support adapter.

27. The patient support apparatus of claim 26, wherein the litter support brace defines a coupling void configured to receive a fastener to limit movement of the litter support brace relative to the litter support adapter.

28. The patient support apparatus of claim 21, wherein the litter support structure does not include a weigh system.

29. (canceled)

30. The patient support apparatus of claim 21, wherein the litter support structure comprises:
an intermediate frame; and
a patient support deck operatively attached the intermediate frame, the patient support deck defining a patient support surface for supporting a patient;
wherein the litter support brace is operatively attached to the intermediate frame.

31. The patient support apparatus of claim 21, wherein the litter support structure comprises:
a weigh frame;
an intermediate frame spaced above and operatively attached to the weigh frame; and
a patient support deck operatively attached the intermediate frame, the patient support deck defining a patient support surface for supporting a patient;
wherein the litter support brace is operatively attached to the weigh frame.

32. (canceled)

33. The patient support apparatus of claim 21, wherein:
the base assembly extends between a head end and a foot end;
the lift mechanism includes a head end lift subassembly and a foot end lift subassembly; and
the litter support coupler is further defined as:
a head end litter support coupler operatively attached to the head end lift subassembly, and
a foot end litter support coupler operatively attached to the foot end lift subassembly.

34. The patient support apparatus of claim 33, wherein the lift mechanism further comprises a head end actuator operatively attached to the litter assembly and the head end lift subassembly to raise and lower the head end lift subassembly relative to the base frame.

35. The patient support apparatus of claim 33, wherein the base frame defines a head end channel configured to receive the head end lift subassembly and guide the head end lift subassembly longitudinally along the base frame as the head end lift subassembly moves relative to the base frame.

36. The patient support apparatus of claim 33, wherein the lift mechanism further comprises a foot end actuator operatively attached to the litter assembly and the foot end lift subassembly to raise and lower the foot end lift subassembly relative to the base frame.

37. The patient support apparatus of claim 33, wherein the base frame defines a foot end channel configured to receive the foot end lift subassembly and guide the foot end lift subassembly longitudinally along the base frame as the foot end lift subassembly moves relative to the base frame.

38. The patient support apparatus of claim 33, wherein the lift mechanism further comprises a timing linkage extending between the head end lift subassembly and the base frame to coordinate motion of the head end lift subassembly relative to the base frame.

39. The patient support apparatus of claim 33, wherein the lift mechanism further comprises a timing linkage extending between the foot end lift subassembly and the base frame to coordinate motion of the foot end lift subassembly relative to the base frame.

40. The patient support apparatus of claim 33, wherein the litter support receiver is further defined as:
a head end litter support receiver configured to engage the head end litter support coupler to couple the litter assembly to the base assembly; and
a foot end litter support receiver configured to engage the foot end litter support coupler to couple the litter assembly to the base assembly.

41. The patient support apparatus of claim 40, wherein:
the head end litter support receiver is further defined as a pair of head end litter support receivers spaced laterally from each other;
the head end litter support coupler is further defined as a pair of head end litter support couplers spaced laterally from each other; and
the pair of head end litter support receivers are configured to engage the pair of head end litter support couplers to couple the litter assembly to the base assembly.

42. The patient support apparatus of claim 40, wherein:
the foot end litter support receiver is further defined as a pair of foot end litter support receivers spaced laterally from each other;
the foot end litter support coupler is further defined as a pair of foot end litter support couplers spaced laterally from each other; and
the pair of foot end litter support receivers are configured to engage the pair of foot end litter support couplers to couple the litter assembly to the base assembly.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)
